(19) United States
(12) Patent Application Publication
(10) Pub. No.: US 2022/0197702 A1
(43) Pub. Date: Jun. 23, 2022

(54) METHOD AND SYSTEM FOR MEMORY MANAGEMENT ON THE BASIS OF ZONE ALLOCATIONS AND OPTIMIZATION USING IMPROVED LMK

(71) Applicant: ARRIS Enterprises LLC, Suwanee, GA (US)

(72) Inventor: Sundaramoorthy BALASUBRAMANIAN, Bangalore (IN)

(73) Assignee: ARRIS Enterprises LLC, Suwanee, GA (US)

(21) Appl. No.: 17/529,944

(22) Filed: Nov. 18, 2021

Related U.S. Application Data
(60) Provisional application No. 63/128,228, filed on Dec. 21, 2020.
(60) Provisional application No. 63/128,385, filed on Dec. 21, 2020.

(51) Int. Cl. G06F 9/50; G06F 12/123; G06F 12/0882

(52) U.S. Cl. CPC G06F 9/5016; G06F 9/5022; G06F 2209/508; G06F 12/0882; G06F 2209/503; G06F 12/123

(57) ABSTRACT

The present disclosure provides a description of systems and methods for memory management on the basis of zone allocations. A computing device analyzes the monitored memory usage information of the user device and outputs an analysis of the monitored memory usage information. The analysis of the monitored memory usage information includes a system level memory usage view of the user device, a memory usage view of a high zone portion of the memory of the user device, and a memory usage view of a low zone portion of the memory. A user device receives a request to allocate memory for a new process. The user device, in response to determining that there is insufficient free pages in either the high zone portion or the low zone portion of the memory, sends a memory pressure notification to a low memory killer daemon of the user device.

### CROSS-REFERENCE TO RELATED APPLICATIONS

This application claims the benefit of and priority to U.S. Provisional Application No. 63/128,228, entitled “METHOD AND SYSTEM FOR MEMORY MANAGEMENT OPTIMIZATION USING IMPROVED LMK,” filed on Dec. 21, 2020. This application also claims the benefit of and priority to U.S. Provisional Application No. 63/128,385, entitled “METHOD AND SYSTEM FOR ANDROID MEMORY MANAGEMENT ON THE BASIS OF ZONE ALLOCATIONS”, filed on Dec. 21, 2020. The entire contents of U.S. Provisional Application Nos. 63/128,228 and 63/128,385 are incorporated herein by reference.

### TECHNICAL FIELD

The present disclosure generally relates to a method and system for memory management on the basis of zone allocations.

### BACKGROUND

Designers of operating systems seek to optimally utilize computer resources such a memory resources. One particular resource where optimal utilization is vital to the performance of the operating system is a memory. A memory is a typically a hardware random access memory (RAM) resource that stores data so that future requests for the data can be served faster than if the data were retrieved from a hard drive. However, memory size is small relative to hard drives and, as a result, can store a much more limited amount of data than that of a hard drive. In mobile devices such as smartphone, the memory may be even smaller than that of larger computing devices (e.g., personal computers, servers, laptops, etc.) due to their smaller form factor. In mobile operating systems, such as the Android operating system, there is an ever present need to optimally utilize memory resources of the mobile device.

Memory pressure is a state in which the system of a computing device (e.g., a mobile device) has relatively little available/free memory to execute processes. As more and more processes are executed in parallel that utilize memory resources of the mobile device, the memory pressure increases until the memory is exhausted. Once exhausted, performance of the mobile device becomes severely impaired as noticeable delays are required to perform the additional processing as not all of the processes can be performed in parallel.

To avoid such performance degradation, operating systems periodically seek to relieve memory pressure (e.g., trim/free unneeded or lesser needed memory from its processes). As an example, a mobile operating system will seek to free memory from the background processes when there is not enough to keep as many processes executing in the background as desired. In order to trim/free the memory, the operating system issues a memory pressure event to an android low memory killer (LMK) daemon (LMKD) so that the LMKD kills processes. Also, ActivityManagerservice sends on trim calls to the background apps so that they release some amount of memory.

Android uses a Linux kernel that allocates two zones in the RAM—namely, a low zone and a high zone. An application executing in connection with an Android operating system uses memory from one or both zones. As a result, any one of the zones that begins to have issues allocating memory, the Linux kernel generates a memory pressure event to cause utilization of the LMKD.

In the Android operating system, whenever a memory allocation request is received by a kernel memory allocator for use with a new process, the memory allocator tries to allocate memory from a corresponding zone (e.g., high zone or low zone of the RAM). If the memory allocator is unable to allocate memory from the requested zone of the memory, the memory allocator will send a memory pressure event to Android's native LMKD process. The LMKD kills an executing process based on an out-of-memory (OOM) score and a least recently used (LRU) process list until the LKMD is able to retrieve the requested memory. The problem is that the LKMD is not aware of the zone (e.g., high zone or low zone) which is under memory pressure. The LMKD kills currently-executing processes based on the LRU process list and the OOM score, which does not factor in the zone under pressure. As a result, the LMKD kills processes even if the process being killed are not occupying a large portion of memory in the zone under pressure. As an example, in an instance where the low zone portion of the memory is under pressure and the top processes in the LRU process list consume more memory in the high zone portion of the memory than the low zone portion of the memory, the LMKD kills the those top processes occupying more memory in the high zone rather than the processes occupying more memory in the low zone that is under memory pressure. As another example, in an instance where the high zone portion of the memory is under memory pressure and the top processes in the LRU process list consume more memory in the low zone portion of the memory than the high zone portion of the memory, the LMKD kills the those top processes occupying more memory in the low zone rather than the processes occupying more memory in the high zone that is under memory pressure.

To this end, in a mobile device executing an Android operating system, there is a need to understand the behavior of memory pressure to enable optimal utilization of the memory resources.

### SUMMARY

In accordance with illustrative embodiments, a method and apparatus are disclosed that allows a memory view from the system level to the zone level resulting from the Linux kernel.

In one or more arrangements, a memory management computing device may be configured to perform a method. The method may include a step of transmitting, by the memory management computing device and to a user device, a first set of instructions to configure the user device to monitor memory usage of the user device and collect monitored memory usage information. The method may include a step of receiving, by the memory management computing device and from the user device, the monitored memory usage information of the user device. The method may include a step of analyzing, by the memory management computing device, the monitored memory usage information of the user device to produce an analysis of the monitored memory usage information. The method may include a step of outputting, by the memory management computing device, the analysis of the monitored memory usage information. The analysis of the monitored memory usage information may include a system level memory usage view of the user device, a memory usage view of a high zone portion of the memory of the user device, and a memory usage view of a low zone portion of the memory of the user device.

In one or more arrangements, a user device may be configured to perform a method. The method may include a step of receiving, by a user device, a request to allocate memory for a new process. The new process is to be allocated memory in a high zone portion of a memory of the user device and memory in a low zone portion of the memory of the user device. The method may include a step of determining, by the user device, whether there is sufficient free pages in the high zone portion of the memory to allocate memory for the new process. The method may include a step of determining, by the user device, whether there is sufficient free pages in the low zone portion of the memory to allocate memory for the new process. The method may include a step of in response to determining that there is insufficient free pages in either the high zone portion or the low zone portion of the memory, sending a memory pressure notification to a low memory killer daemon in the user space. The method may include a step of killing, by the low memory killer daemon, one or more processes using memory pressure information specific to either the high zone portion or the low zone portion of the memory, an out-of-memory score, and a least recently used list of processes being executed by the user device.

A computing device may include a processor and a memory storing instructions that, when executed by the processor, causes the computing device to perform the above-described methods.

A system may include a computing device configured to perform the above-described methods.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 depicts a block diagram of a high-level system architecture of a system for memory management on the basis of zone allocations in accordance with illustrative embodiments.

FIG. 2 depicts a flow chart of an illustrative method in accordance with illustrative embodiments.

FIG. 3 depicts a block diagram of a high-level system architecture for a portion of a user device 108 and an ontrim call flow 200 in accordance with illustrative embodiments.

FIGS. 4-13 depicts illustrative user interfaces of memory usage analysis in accordance with illustrative embodiments.

FIGS. 14-16 depicts a flow chart of an illustrative method in accordance with illustrative embodiments.

FIG. 17 depicts a block diagram depicting a computer system architecture in accordance with illustrative embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

### System for Memory Management on the Basis of Zone Allocations

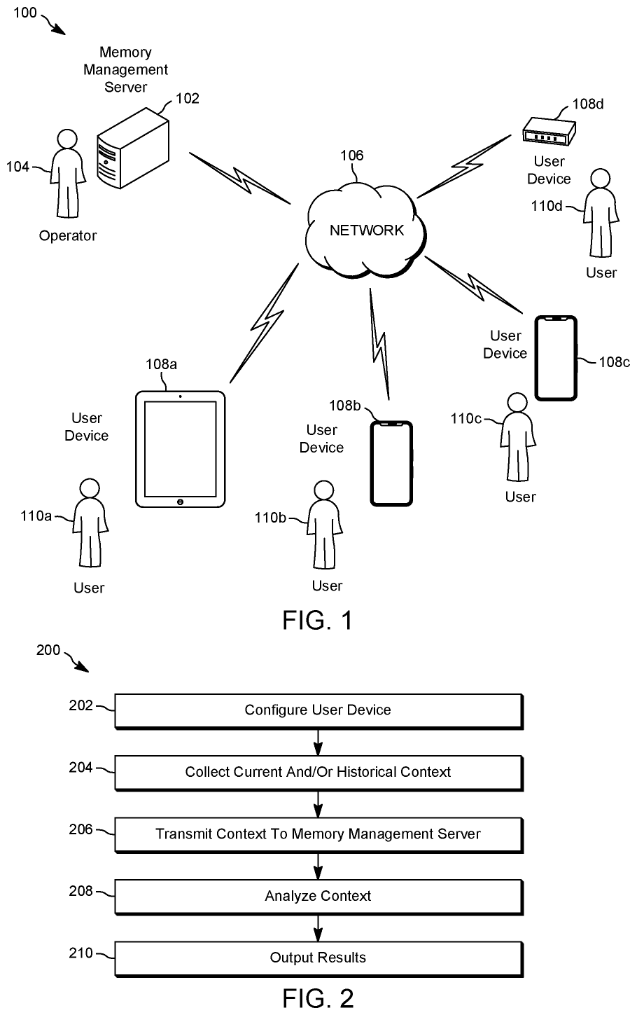

FIG. 1 depicts a block diagram of a high-level system architecture for memory management on the basis of zone allocations. The architecture may be embodied in a system 100, which includes a memory management server 102, an operator 104, one or more networks 106, multiple user devices 108, and users 110. Each of the servers/devices may communicate with one or other servers/devices via one or more networks 106. The one or more networks 106 may be wired or wireless, or a combination thereof.

The memory management server 102 may be responsible for managing memory of the user devices 108. For instance, the memory management server 102 may collect/retrieve data concerning the current or historical system context from the user devices 108. The context may include the current memory usage of each process and/or application, a list of currently executed applications, usage information of each of these applications, processor usage, and processor performance statistics, which may be on a per process and/or a per application basis. Usage information may include, for example, whether the application's process is being executed in the background or foreground. Foreground processes correspond to applications currently being executed and that a user is interacting with (e.g., via a GUI). Background processes correspond to applications that are running but not being interacted with by the user. For each item/event included in the system context information, there may be corresponding timestamps of when the item/event occurred so that the items/events may be subsequently arranged in chronological order. Context information may also include application memory usage, application memory usage breakup, linux zone level memory information, application CPU usage history, Gfx memory usage, and geographical location of the user device 108.

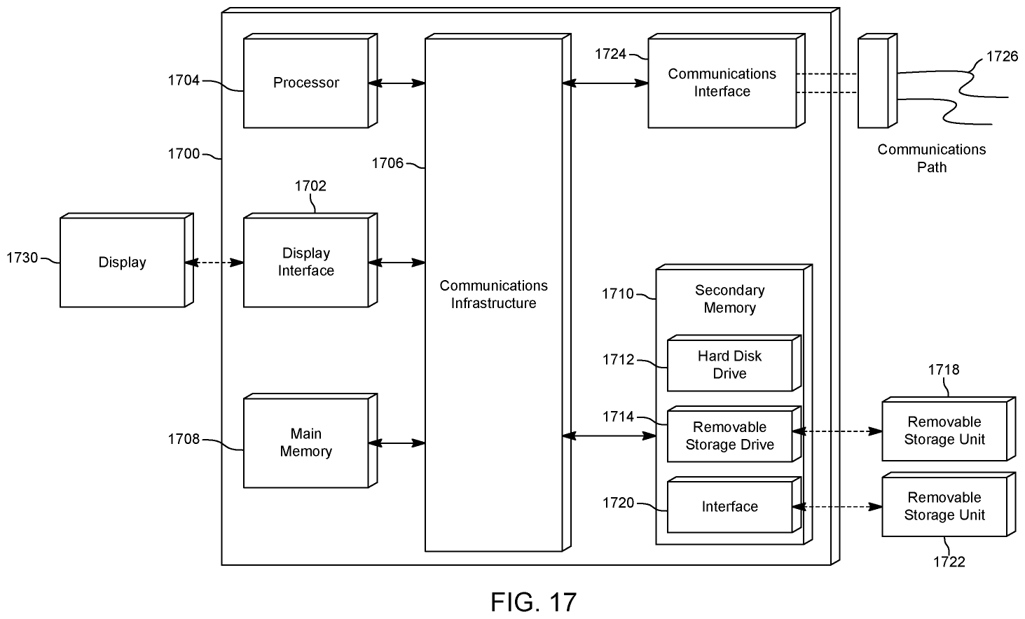

The memory management server 102 may be a computing system/device as described below in FIG. 17. The memory management server 102 may include a man-machine interface (MMI) to permit the operator 104 to interact and/or otherwise control operation of the memory management server 102. For instance, the memory management server 102 may include a display (e.g., monitor) to display a graphical user interface (e.g., a touchscreen), a keyboard, a mouse and/or touchpad, a speaker, a microphone, a camera, and/or any other interfaces for interaction between the operator 104 and the memory management server 102.

The memory management server 102 may include a processor and memory storing a diagnostic tool (e.g., a software application) for managing memory of the user devices 108. The diagnostic tool may be executed by the processor to cause the memory management server 102 to perform any actions of the memory management server 102 described herein. As used herein, functions being described as being performed by the memory management server 102 may be considered as being performed by the diagnostic tool. The memory management server 102 may be responsible for managing data it collects from the user devices 108, performing an analysis on the collected data, and analyze the results. Such data may be stored in one or more databases such as a structure query language (SQL) database.

User devices 108 may be responsible for collecting and transmitting its current and/or historical context (e.g., memory usage, processor usage) to the memory management server 102, in accordance with instructions received from the memory management server 102. In one or more arrangements, the user devices 108 may install a diagnostic agent (e.g., a software application) that is configured to interact with and follow the instructions of the diagnostic tool of the memory management server 102. The user devices 108 may be a computing system/device as described below in FIG. 17. Examples of user devices 108 include set-top boxes, smart televisions, computers, tablets, smartphone, and the like.

Many of these user devices 108 may utilize the Android operating system. Android is not an embedded system with predefined applications. As a result, optimizing the memory and processor of a user device 108 to guarantee stable performance is a challenge. Aspects discussed herein relate to the memory management server 102 and its diagnostic tool for monitoring system behavior of the user devices 108 to identify applications and resource usage patterns to determine the root cause of different system behaviors. Using this knowledge, the diagnostic tool may issue commands to the user devices 108 to adjust memory management so as to increase performance (e.g., processing speed) of the user device's 108 Android system. Further, the operator 104 may use the diagnostic tool to monitor the resource usage on one or more of the user devices 108. For instance, the diagnostic tool may be used to monitor memory and processor performance from the system down to the kernel level. The diagnostic tool may also be used to fine tune the memory layout to support different sets of applications being executed by a user device 108. The diagnostic tool may be used to speed up root cause analysis (RCA) in stability and performance issues. The diagnostic tool may be used to help the operator understand application system level resource usage. For instance, the diagnostic tool may be used to generate graphs/charts of different events including effects of commands such as low memory killer, ontrimmemory application switch, and application not responding (ANR).

Method for Managing Memory Pressure

FIG. 2 depicts an illustrative flow diagram in accordance with illustrative embodiments. The method may being at step 202 in which an operator 104 configures a user device 110. For instance, the operator 104 may, using a computing device (e.g., user device, computer, tablet, set-top box and a display, etc.), navigate to a settings webpage of a diagnostic tool of the memory management server 102. The webpage of the diagnostic tool may include fields to enter one or more identifiers of the user device (e.g., a serial number of a set-top box, a media access control (MAC) address of the user device, and/or Internet Protocol (IP) address of the user device). The webpage of the diagnostic tool may include a field to enter an elasticsearch logstash kibana (ELK) Uniform Resource Location (URL) to send collected data from the user device. In some cases, a default URL is prepopulated in the field. The webpage of the diagnostic tool may include a field to enter memory log reporting periodicity (e.g., every few hours, every hour, every few minutes, every minute, etc.). In some cases, a default value is prepopulated in the field (e.g., 5 minutes). The webpage of the diagnostic tool may include a field to enter log data reporting periodicity (e.g., (e.g., every, week, every day, every few hours, every hour, every few minutes, etc.). In some cases, a default value is prepopulated in the field (e.g., 5 minutes). In some instances, the webpage may include a field for the operator 104 to enter a time period over which to collect context information (e.g., a day, a few hours, an hour, etc.). In some instances, the webpage may include a field to specify an event to cause the user device to collect and/or report its context (e.g., memory pressure of the user device's memory raising above a threshold set by the operator 104, free/unused available memory of the user device's memory falling below a threshold set by the operator 104, etc.).

Once the operator 104 is finished entering data in the fields of the settings webpage for the diagnostic tool of the memory management server 102, the operator 104 may select an option to submit the values entered in the fields (e.g., pressing a submit on-screen button). Once submitted, the diagnostic tool of the memory management server 102 may formulate, based on the values of the fields entered by the operator 104, one or more instructions for collecting data and transmit those instructions to the user device identified by the user 110 or operator 104.

For instance, the memory management server 102 may send, to the identified user device 108, instructions for the user device 108 to collect/track its system context information over a predetermined period of time (e.g., an hour, a day, a week, a month, etc.). As discussed above, the context may include the current memory usage of each process and/or application, a list of currently executed applications, usage information of each of these applications, and processor performance statistics, which may be on a per process basis and/or a per application basis. The instructions may also include an instruction to collect the system context information in response to the occurrence of a predefined event (e.g., switching applications between the foreground and background, an action caused by LMKD, available memory falling below a preset threshold such as 2 megabytes, processor speed falling below a preset threshold, etc.). The instructions may include an instruction to collect the system context information at a predetermined interval (e.g., once a minute, once an hour, once a day, etc.). Collected information may be stored by the identified user device 108 in a log.

The instructions may include an instruction for the user device 108 to transmit the current and/or historical system context information (e.g., the information collected over the predetermined period) to the memory management server 102. This instruction may include one or more of a predetermined internal in which the collected/logged context information is to be sent to the memory management server 102. This instruction may specify an event that if occurs causes the user device 108 to transmit its collected/logged context information to the memory management server 102. In one or more arrangements, the memory management server 102 may also transmit collected/logged context information to the memory management server 102 in response to receiving a request for such information from the memory management server 102.

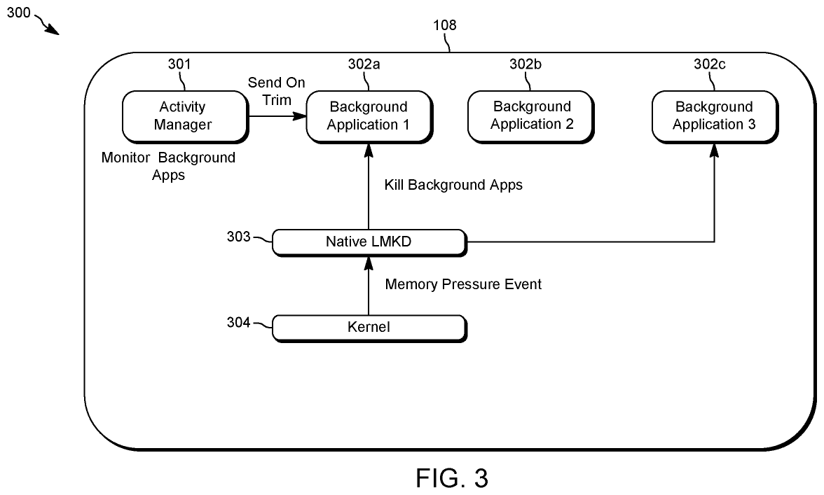

At step 204, the user device 108 may collect current and/or historical context information of the user device 108. FIG. 3 depicts a block diagram of a high-level system architecture 300 for a portion of a user device 108 and example flow of collecting context information, in accordance with instructions received from the memory management server 102. The user device 108 includes the following software programs: an activity manager 301, one or more background applications 302, a native LMKD 303, and a kernel 304. Each of these software programs may be stored in various hardware memory of the user device 108. As an example, the one or more background application 302 may be stored in the memory of the user device 108. Each of these software programs may be executed by the processor of the user device 108.

The kernel 304 sends a trigger message for memory pressure events to the LMKD 303, which is a service native to the Android operating system, when a low or no memory situation arises. A low or no memory situation arises when the free memory goes below a predetermined minimum memory threshold for the zone. As discussed above, as the memory pressure increases, more of the memory of the user device 108 is being used and, as a result, less memory is left available/free for use by various processes/applications.

Once the LMKD 303 receives the trigger message from the kernel 304, the LMKD 303 starts killing the background processes based on the LMKD's preset configuration. At the same time, the Android activity manager service (AMS) 301 monitors the number of background processes (e.g., background applications) being executed by the user device 108. The AMS 301 determines different memory pressure levels based on the current active cached processes.

In some instances, the system memory pressure may be determined based on the number of cached processes in comparison with predefined thresholds. A cached process may be a process that has some or all of its data for use in the process stored in the memory of the user device 108. If the number of cached processes is greater than or equal to a first predetermined threshold (e.g., 8), the memory pressure may be considered normal. If the number of cached process is less than the first predetermined threshold (e.g., 8), the memory pressure may be considered moderate. If the number of cached processes is less than a second predetermined threshold (e.g., 5), the memory pressure may be considered low. If the number of cached process is less than a third predetermined threshold, the memory pressure may be considered critical (i.e., a low memory situation).

In some instances, the memory pressure may be determined based on the amount of available (e.g., unused) memory in the memory of the user device 108. As an example, if the amount of available or unused memory in the memory falls below a predetermined threshold, a low memory condition has occurred. The predetermined threshold may be an amount of memory to perform one process.

The AMS 301 may send an ontrimmemory( ) call to one or more applications being executed. Examples of the ontrimmemory( ) call include trim memory UI hidden call, trim memory background call, trim memory running moderate call, trim memory complete call. The particular types of ontrimmemory( ) call may be based on the determined system memory pressure. As a result of the ontrimmemory( ) call, processes release a certain amount of memory.

During the above described call flow, the user device 108, based on the instructions received from the memory management server 102, monitor memory as well as track various items and events at either predefined intervals or in response to an events (e.g., memory pressure triggers, LMKD processes, sending of ontrimmemory calls, etc.). For instance, the user device 108 monitors processes/applications use of its memory and processor and adds information to its context information log. Information monitored and tracked includes proportional set size (PSS). A PSS for a process includes the portion of the memory (e.g., RAM) used and unshared by the process as the proportion of shared memory with other processes. Android has different categories of processes like Persistent, Perceptible, Foreground, Cached, System, and Native. The user device 108 monitors PSS of each process in this category and a total PSS value for each category. Other information monitored and tracked includes cached kernel, amount of free/available memory in the cache, lost memory, memory pressure information, etc.

The memory of the user device 108 has a high zone and a low zone allocated by the kernel 304. The user device 108 monitors processes/applications use of the low zone portion of its memory and adds information to its context information log. For instance, the user device 108 monitors low memory free pages, low memory kswapd threshold, and low memory zone balance threshold. These values may be monitored using zone information which is calculated by the kernel. The user device 108 monitors processes/applications use of the high zone portion of its memory and adds information to its context information log. For instance, the user device 108 monitors high memory free pages, high memory kswapd threshold, and high memory zone balance threshold. Further, for the high zone has a contiguous memory allocator (CMA) region used for GFX, the user device 108 monitors CMA LMK threshold, CMA total memory com. Whenever any process CMA usage goes above CMA threshold, then that process will be killed by CMA LMK.

For each of the above-listed monitored and tracked information, the user device 108 may affix a timestamp for each measurement of when the measurement was taken and associate the timestamp with the corresponding measurement. The user device 108 may add this information to its context information log.

Returning to FIG. 2, at step 206, the user device 108 may transmit the current and/or historical system context information (e.g., the information collected over the predetermined period) to the memory management server 102. In some instances, the user device 108 may transmit the context information after at the interval and/or after the predetermined period of time has elapsed, as specified in the instructions. Additionally or alternatively, the user device 108 may transmit the context information in response to a request by the memory management server 102. In some embodiments, the context information may be transmitted in Javascript Object Notation (JSON) format.

At step 208, the user device 108 may analyze the current and/or historical system context information (e.g., the information collected over the predetermined period). For instance, the diagnostic tool of the memory management server 102 may determine application memory usage, application memory usage breakup, linux zone level memory information, application CPU usage history, Gfx memory usage, and geographical location of the device.

At step 210, the diagnostic tool of the memory management server 102 may output results of the analysis of step 208. In some instances, in order to determine reasons the android system is under memory pressure, the memory management server 102 display, based on the analyzed current and/or historical system context information, a memory view from a system level down to Linux zone levels. These memory views may be displayed to the operator 104. In some instances, the views may be displayed via a webpage via a web porting tool of the memory management server 102.

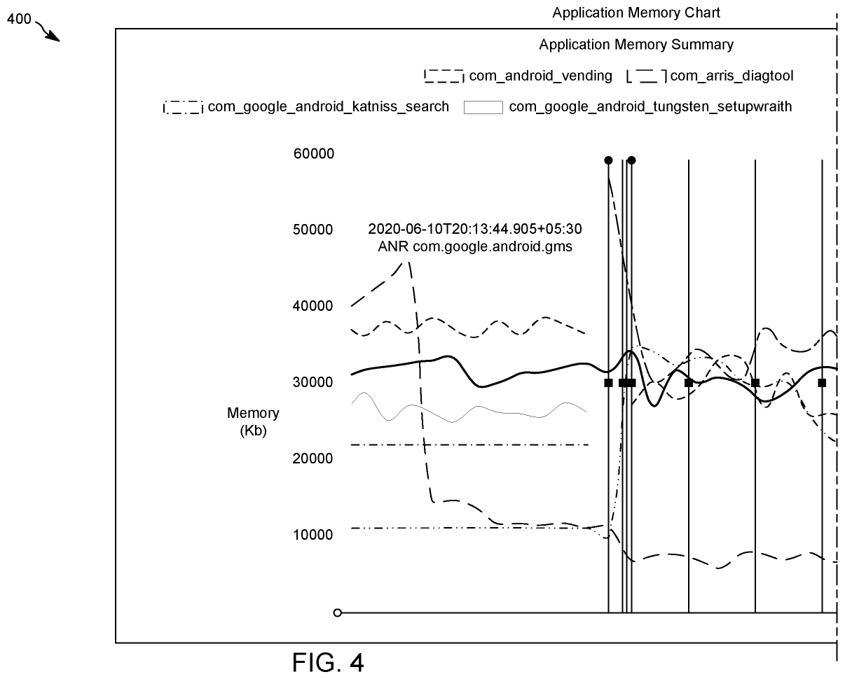

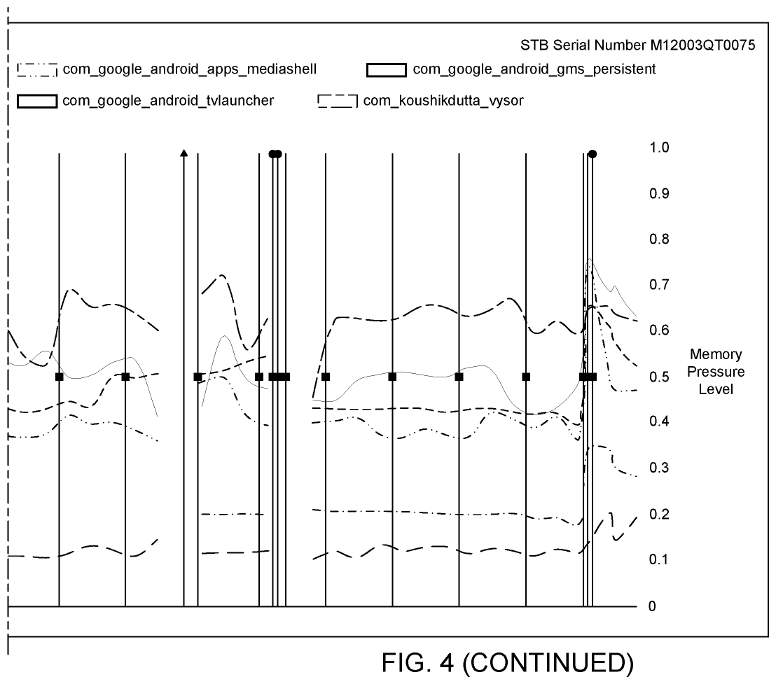

FIGS. 4-12 depict various user interfaces of memory charts for view/interaction by the operator 104. FIG. 4 depicts a memory view illustrating memory usage of applications being executed by the user device 108 over the last 24 hours. The user interface 400 may depict the memory pressure caused by each application. The user interface 400 permits the operator 104 to select/deselect particular applications using application labeled checkboxes. Vertical lines are event annotations with colored circles on them. As the operator 104 moves a mouse pointer or the like over the circle, the user interface will display a pop up window including the event timestamp and event details. Different colors may be used for circles relating to different events. A first color of a circle may be used to represent LMKD. A second color of a circle may be used to represent ANR and/or OnTrimMemory. A third color may be used to represent application's launch time. A third color may be used to represent when the application is in the foreground.

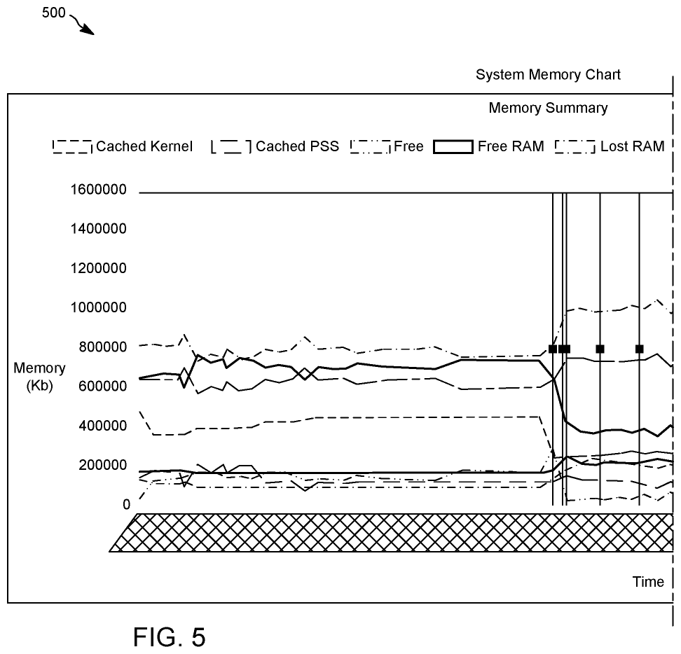

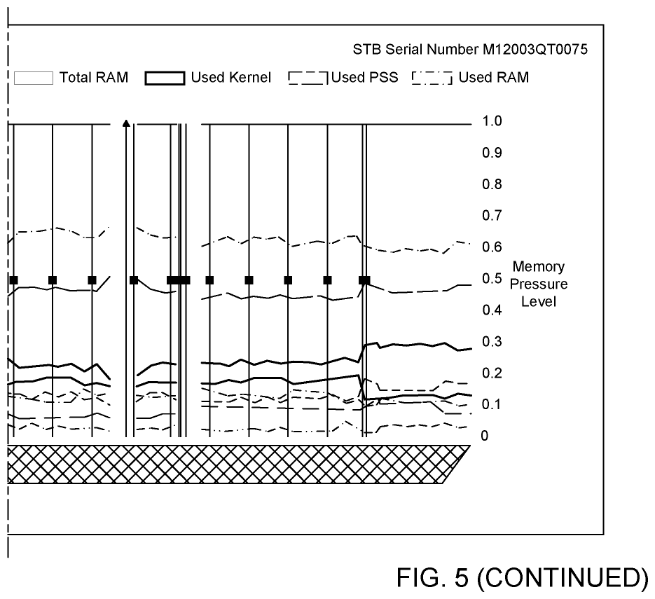

FIG. 5 depicts a memory view chart illustrating system memory usage of the user device 108 over the last 24 hours. The user interface 500 may plot analysis (e.g., memory pressure) of the cached kernel usage which amount of memory cached by kernel, cached PSS which is amount of memory used by background process, free memory which is total free memory that includes free RAM and cached memory, free RAM which is actual free memory, lost RAM which is not accommodated in either free or cached, total RAM which is available after soc preallocation, used kernel which is memory used by kernel, used PSS which is memory used by userspace.

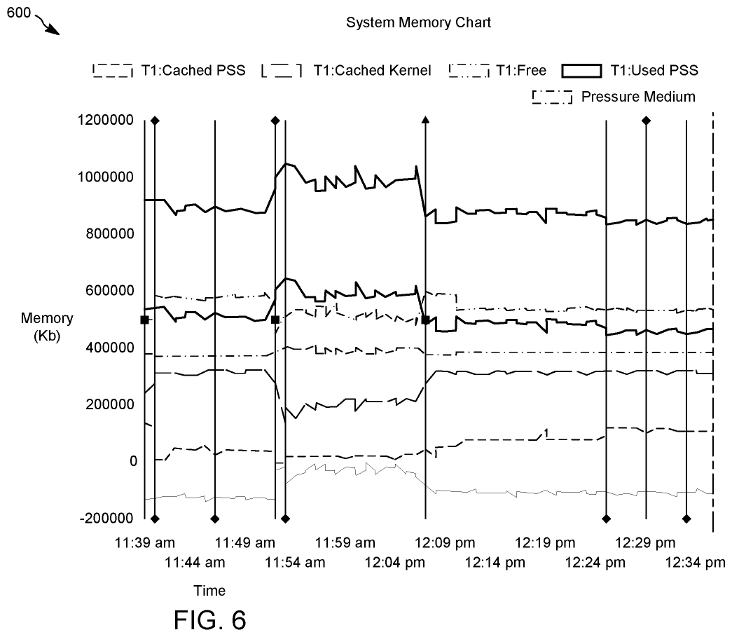

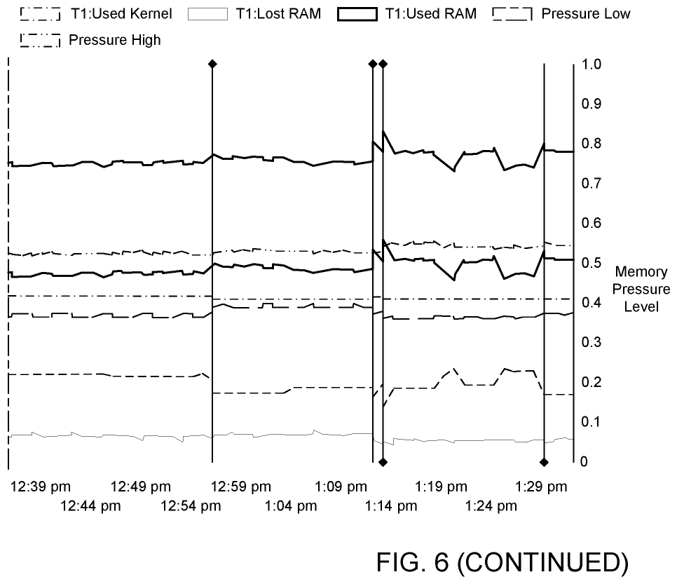

FIG. 6 depicts another memory view chart illustrating system memory usage of the user device 108 over a time period (e.g., the time period specified by the operator 104). The user interface 600 may plot, for example, cached PSS, cached kernel, free memory, used PSS, used kernel, lost RAM, used RAM, memory pressure low indication, memory pressure medium indication, memory pressure high indication, etc.

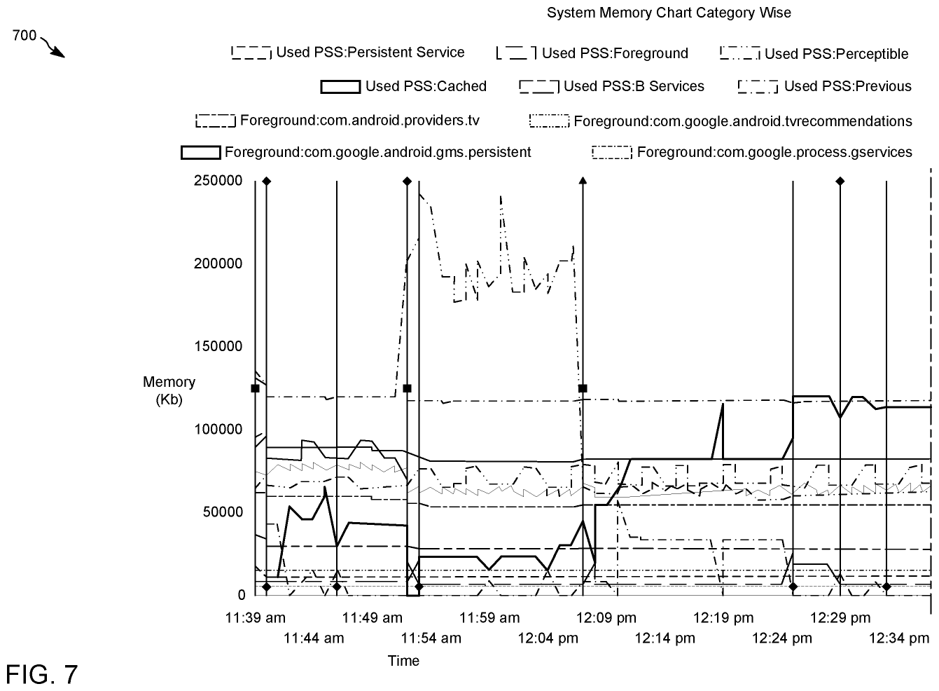

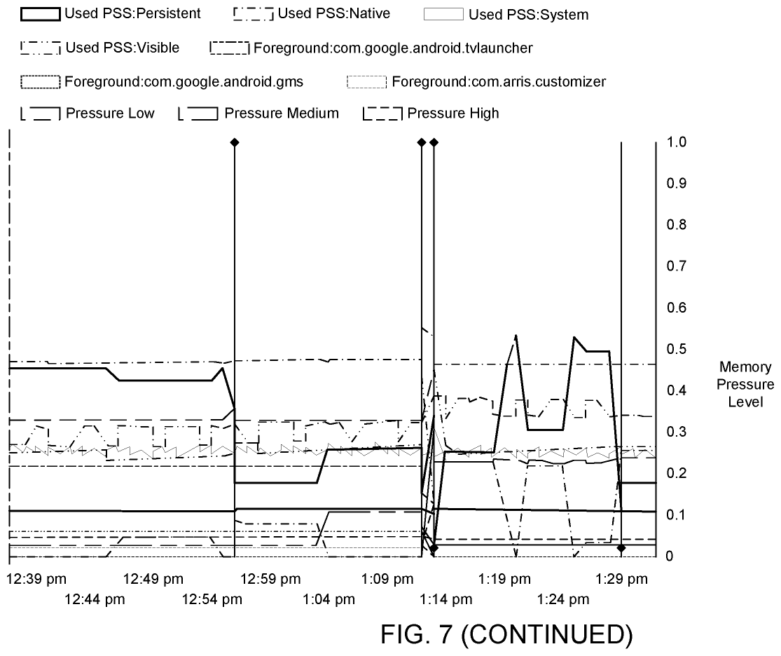

FIG. 7 depicts a memory view chart illustrating memory usage of different category wise of user device 108 over a time period (e.g., the time period specified by the operator 104). The user interface 700 may plot, for example, used PSS of persistent service category, used PSS of foreground process, used PSS of perceptible category, used PSS of persistent category, used PSS of native processes, used PSS of system, used PSS of cached processes, used PSS of B services, used PSS of previous processes, used PSS of visible processes and PSS of foreground process. Also, displays System memory pressure.

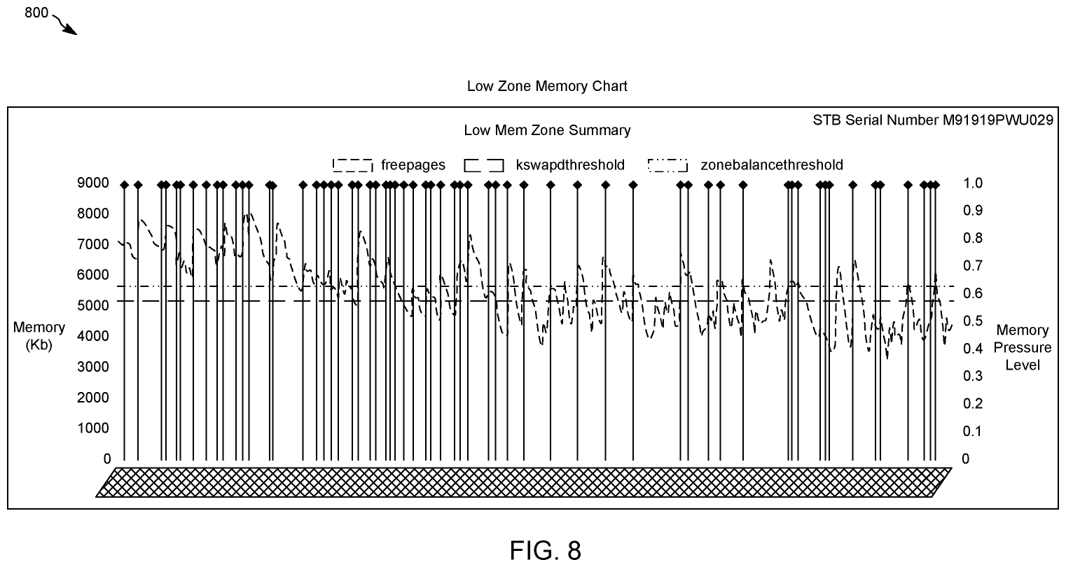

FIG. 8 depicts a memory view chart illustrating memory usage of the low zone memory of the memory of the user device 108 over a time period (e.g., the time period specified by the operator 104). Android process types and its cumulative memory usage is plotted in the user interface 800. User interface 800 may plot, in the chart, free pages which is actual free pages in the low zone, kswapd threshold which equal low zone min threshold, zone balance threshold, etc. When free pages falls below kswapd threshold, kswapd raises and frees pages until free pages goes above the high threshold.

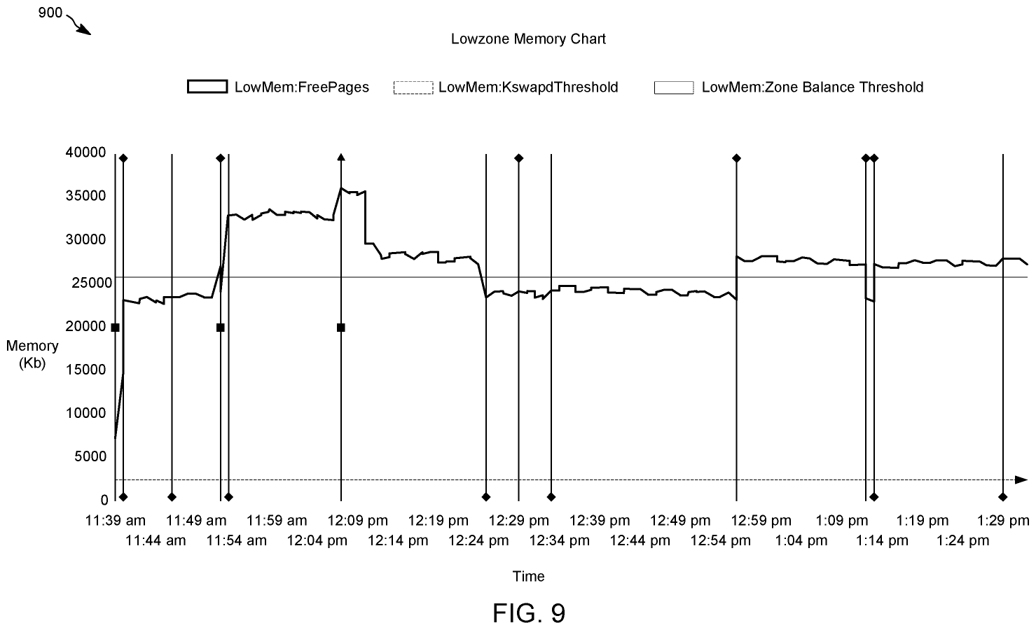

FIG. 9 depicts a memory view chart illustrating memory usage of the low zone of the memory of the user device 108 over a time period (e.g., the time period specified by the operator 104). The user interface 900 may plot low memory free pages, low memory kswapd threshold, low memory zone balance threshold, etc. When free pages falls below threshold, kswapd raises free pages above the high threshold.

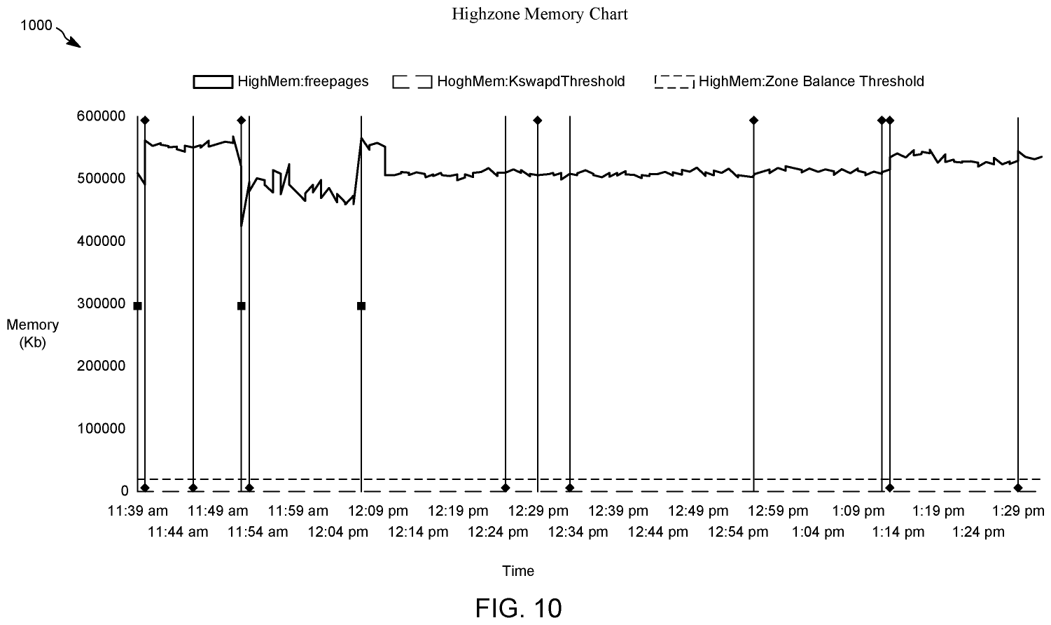

FIG. 10 depicts a memory view illustrating memory usage of the high zone of the memory of the user device 108 over a time period (e.g., the time period specified by the operator 104). The user interface 1000 may plot high memory free pages, high memory kswapd threshold, high memory zone balance threshold, etc. When free pages falls below threshold, kswapd raises free pages above the high threshold.

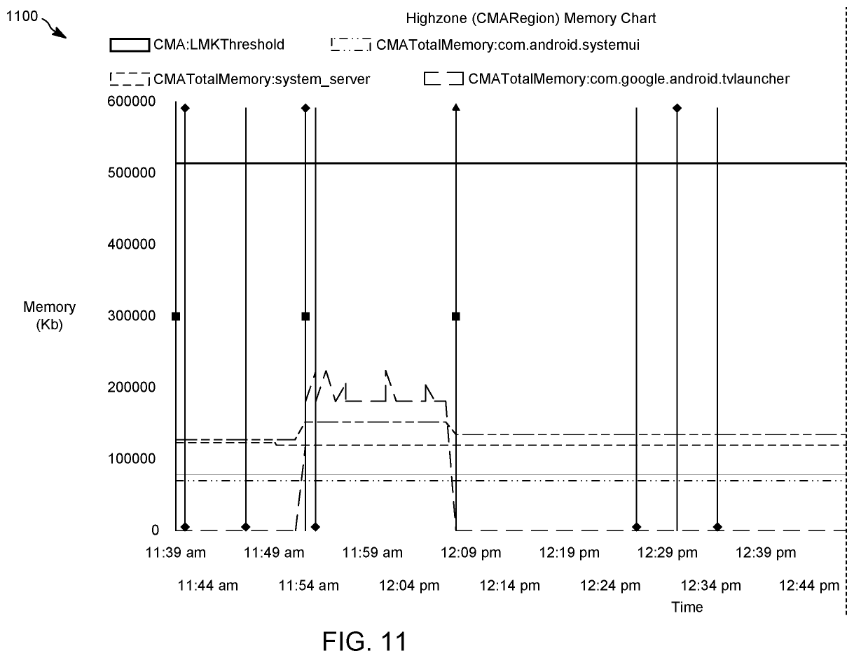

FIG. 11 depicts a memory view chart illustrating memory usage of the high zone (CMA region) of the memory of the user device 108 over a time period (e.g., the time period specified by the operator 104). The user interface 1100 may plot CMA LMK threshold, CMA total memory in android system and CMA usage of each running application.

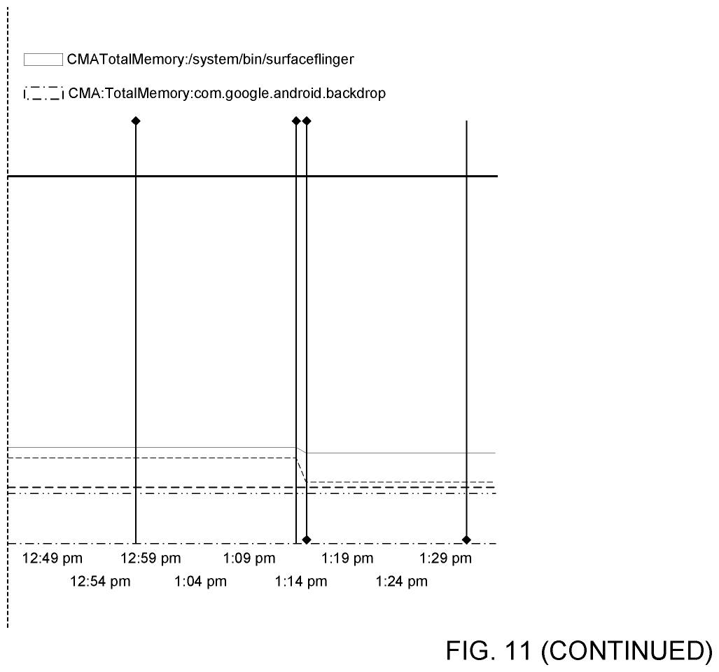

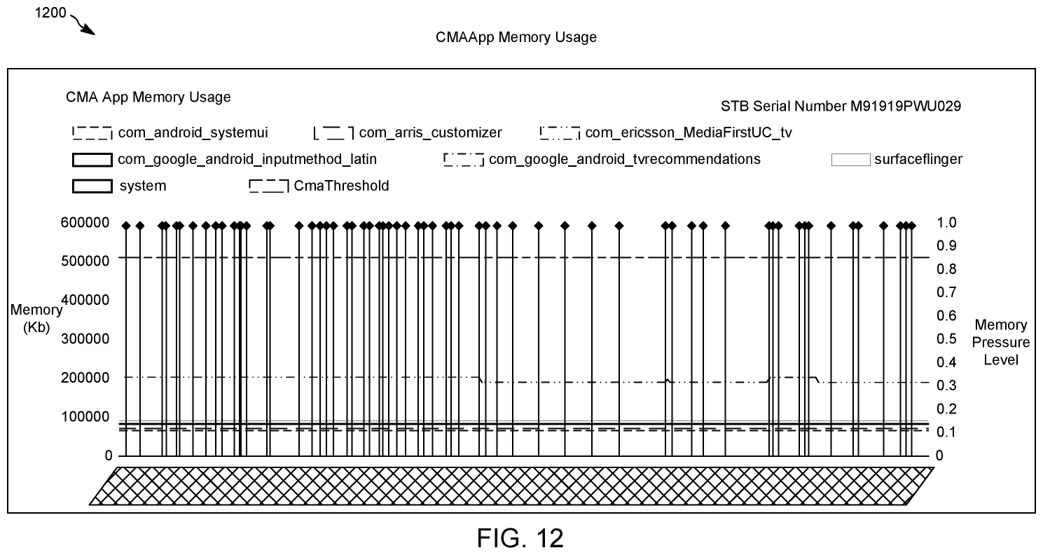

FIG. 12 depicts a memory view chart illustrating memory usage of applications being executed by the user device 108 over a time period and a CMA threshold. The user interface 1200 plots usage of the different applications and the CMA threshold. The CMA LMK monitors the CMA region. When the CMA regions have little (below a threshold) or no free memory, the CMA LMK starts killing applications running in the background to create more free/available memory.

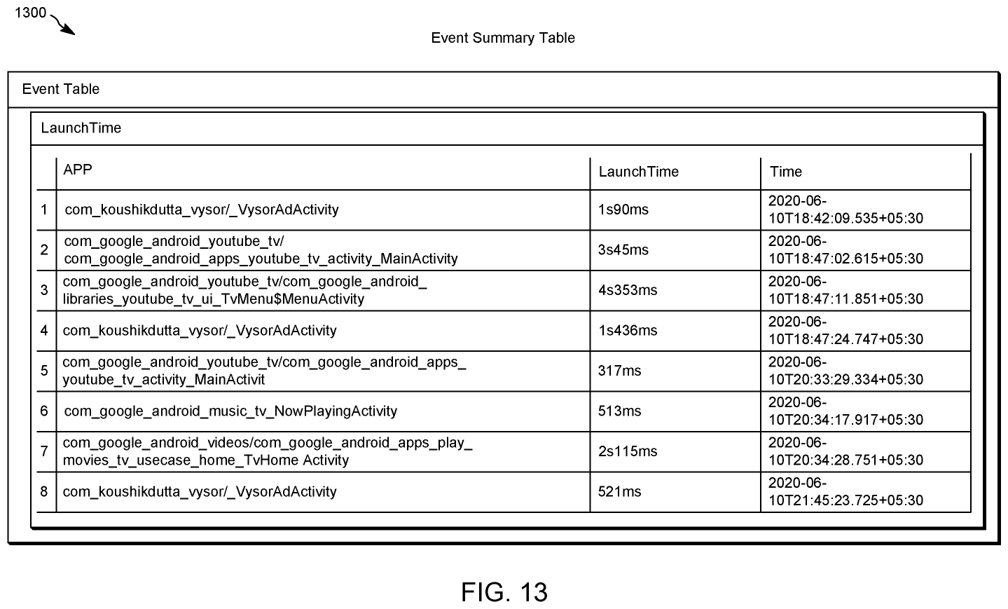

FIG. 13 depicts an event summary table of events occurring at the user device 108 over a time period (e.g., the last 24 hours). The user interface 1300 of the event summary table provides information about application launch times, LMK killed events, and proc start event along with PID and timestamp.

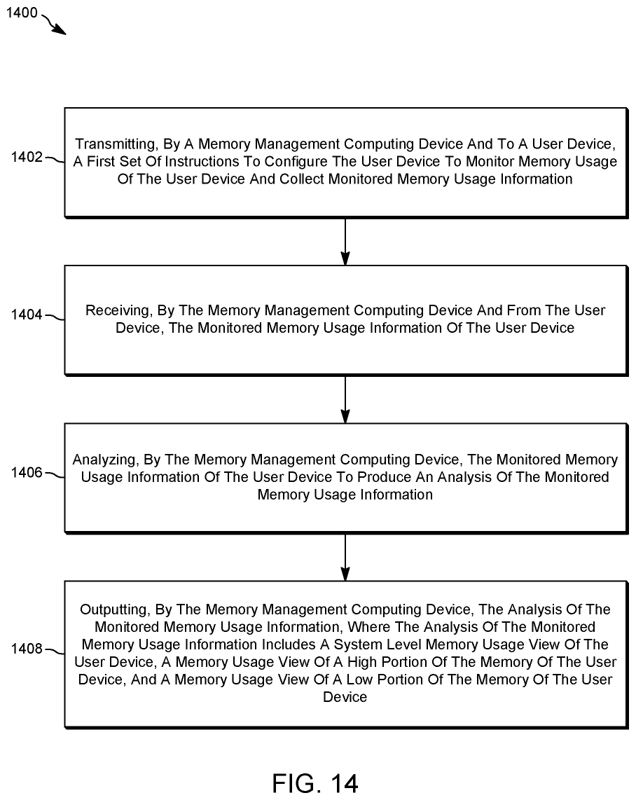

FIG. 14 depicts a flow chart of a method according to one or more aspects discussed herein. At step 1402, a memory management computing device (e.g., memory management server 102) transmits, to a user device (e.g., user device 108), instructions to configure the user device to monitor memory usage of the user device and collect monitored memory usage information. At step 1404, the memory management computing device receives, from the user device, the monitored memory usage information of the user device. At step 1406, the memory management computing device analyzes the monitored memory usage information of the user device to produce an analysis of the monitored memory usage information. At step 1408, the memory management computing device outputs the analysis of the monitored memory usage information. The analysis of the monitored memory usage information includes a system level memory usage view of the user device, a memory usage view of a high zone portion of the memory of the user device, and a memory usage view of a low zone portion of the memory of the user device.

In one or more arrangements, the memory management server 102 may transmit instructions to user device 108 to adjust management of their caches, applications, and processes. In some instance, prior to transmitting the instructions to adjust management of the cache, applications, and/or processes, the memory management server 102 may display the tool's graphical user interface to display received system context information, preliminary analysis of the received system context information, and/or instructions for adjusting management to be sent to the user devices 108 as discussed in additional detail below. The operator 104 may perform additional analysis using the tool and add or adjust instructions for adjusting management of the cache, applications, and/or processes. As an example, with the specific configuration, operator may look for available free memory in both zones. If available free memory is not above the defined threshold, operator may redefine the zone and rerun the test.

One example use case where adjustment of memory management is needed is whenever a memory allocation request is received by a kernel memory allocator of the user device 108 for use with a new process, the memory allocator tries to allocate memory from a corresponding zone (e.g., high zone or low zone of the memory). If the memory allocator is unable to allocate memory from the requested zone of the memory, the memory allocator will send a memory pressure event to Android's native LMKD process. The LMKD kills an executing process based on an out-of-memory (OOM) score and a least recently used (LRU) process list until the LKMD is able to retrieve the requested memory. The problem is that the LKMD is not aware of the zone (e.g., high zone or low zone) which is under memory pressure. The LMKD kills currently-executing processes based on the LRU process list and the OOM score, which does not factor in the zone under pressure. As a result, the LMKD kills processes even if the process being killed are not occupying a large portion of memory in the zone under pressure.

In such a use case, the memory management server 102 determines, based on the analyzed results, that greater memory usage efficiency of the user device 108 may be obtained if the LMKD of the user device 108 is aware of the zone (e.g., high zone or low zone) under memory pressure. To this end, the memory management server 102 may transmit one or more instructions to the user device 108 instructing its LMKD to consider process zone information (e.g., identify zone currently under memory pressure, determine processes using more memory in the identified zone, etc.) in addition to the OOM score and the LRU process list when determine which processes to kill. As a result, the user device 108 will kill processes using more memory in the zone under memory pressure. One benefit of this adjustment to the memory management of the user device 108 is that the LMKD may avoid having to kill more processes because the processes it kills will be using more memory in the zone under memory pressure instead of killing processes that use more memory from the zone not under memory pressure.

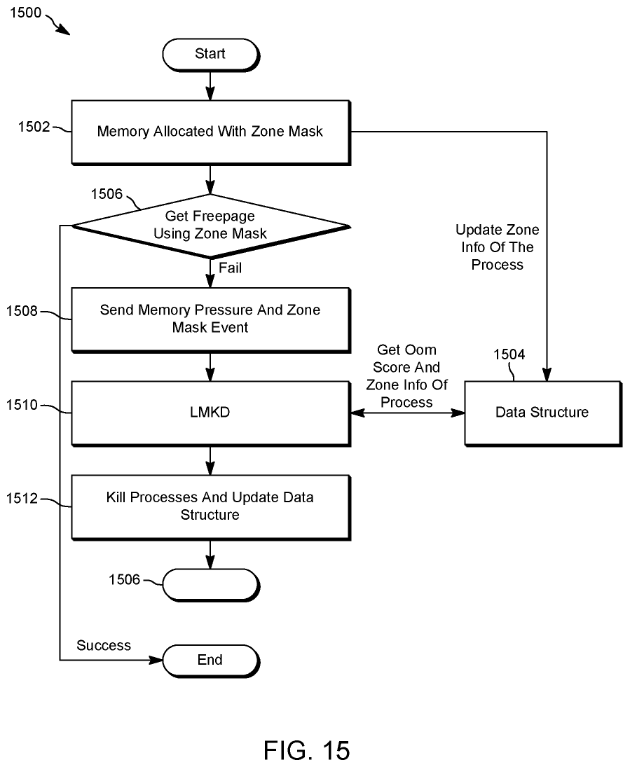

FIG. 15 depicts an illustrative flow diagram 1500 for accounting for zone of memory in accordance with illustrative embodiments. The steps of FIG. 15 may be performed by the user device 108 in accordance with instructions sent to the user device 108 from the memory management server 102. Prior to beginning the process, the instructions received by the user device 108 may cause the user device to generate a data structure (e.g., a table) to track zone information for each process being executed by the user device. The instructions received by the user device may also cause the user device 108 to inspect its memory for currently executing processes (e.g., foreground processes, background processes, etc.) and populate the table with zone information. For each executing process, the table may include a process identifier, amount of memory in the low zone portion of the memory allocated to the process, and the amount of memory in the high zone portion of the memory allocated to the process. This may also be referred to as a “zone mask.”

In one example, the user device 108 may detect a first process utilizing its memory. The user device 108 may either identify or assign a process identifier to the first process. The user device 108 may inspect the low zone portion of the memory to determine the amount of memory in the low zone used by the first process. Similarly, the user device 108 may inspect the high zone portion of the memory to determine the amount of memory in the high zone used by the first process. The user device 108 may store the zone mask for the first process (e.g., the process identifier, the amount of memory used in the low zone, and the amount of memory used in the high zone) in the table as a record. In one or more instances, the inspection of the memory and population of the table may be performed by the user device's 108 Android kernel memory allocator.

The method may begin at step 1502 in which the user device 108's Android kernel memory allocator may receive a request to an allocation of memory for a new process. The user device 108 may determine the zone mask for the new process. Specifically, the user device 108 may identify or generate a process identifier for the new process. The user device 108 may determine an amount of memory of the low zone portion of the memory that will need to be allocated for the new process and an amount of memory of the high zone portion of the memory that will need to be allocated for the new process.

At step 1504, the user device's 108 Android memory kernel may update the data structure (e.g., table) with the process identifier for the new process, the amount of memory of the low zone portion of the memory that will need to be allocated for the new process, and the amount of memory of the high zone portion of the memory that will need to be allocated for the new process. The information may be associated with one another in the chart in, for example, a record.

At step 1506, the user device's 108 Android kernel memory allocator may attempt to allocate memory for the new process using its zone mask. Specifically, the user device 108 may attempt to allocate one or more free pages of the low zone portion of the memory based on the determined amount of memory of the low zone portion of the memory that will need to be allocated for the new process. The user device 108 may attempt to allocate one or more free pages of the high zone portion of the memory based on the determined amount of memory of the high zone portion of the memory that will need to be allocated for the new process. If there are sufficient free pages to allocate the new process, the pages may be allocated to the new process and the method may end.

Otherwise, if there are insufficient free pages in either the low zone portion or the high zone portion of the memory to allocate, the user device's 108 Android kernel memory allocator may, at step, 1508, send a memory pressure event notification to the user device's 108 LMKD. The notification may specify which zone(s) (e.g., high zone and/or low zone) there was insufficient free pages to allocate the new process. That is, the notification may indicate which zones of the memory are under memory pressure. The notification may also include the number of free pages in each zone that are currently able to be allocated to the new process, if any. This may be determined by the user device's Android kernel memory allocator. Additionally or alternatively, the notification may include the amount of free pages in each zone that needs to be freed in order to allocate the new process. This may also be determined by the user device's Android kernel memory allocator. The user device's 108 Android kernel memory allocator may also send the zone mask information for the new process (e.g., process identifier, the amount of memory used in the low zone, and the amount of memory used in the high zone).

At step 1510, the user device's 108 LMKD may retrieve from the data structure, zone information, which may be based on which zone(s) are under memory pressure. For instance, if the high zone portion of the memory is under memory pressure, the LMKD may retrieve zone mask information for processes with allocated memory for the high zone. The LMKD may rank the processes in terms of amount of memory utilized in the high zone portion of the memory.

The LMKD may also retrieve an out-of-memory (OOM) score set by android for each of these processes as well as a least recently used (LRU) process list. The LRU process list ranks processes based on which process has not been used for the longest amount of time. The LMKD may update the ranking of the process based on the OOM score of each of the processes and its ranking in the LRU process list. For example, if the second-ranked process in terms of high zone memory allocation has a higher OOM score and/or is ranked higher in the LRU process list than the first-ranked process in terms of high zone memory allocation, the LMKD may update the list to make the second-ranked process the first-ranked process, and vice versa. This may be repeated for other ranked processes.

Once updated, the LMKD may, at step 512, kill one or more processes to free necessary pages to allocate the new process. Particularly, the LMKD may determine the amount of pages needed for allocation of the new process. The LMKD may also iteratively aggregate the amount of high zone free pages used by the top ranking processes of the updated list until it equals the amount of pages needed for allocation of the new process. The LMKD may kill these processes thereby free pages in the high zone portion of the memory that was under memory pressure. The killing of one or more of these processes may also free pages in the low zone portion of the memory. The LMKD may update the data structure to reflect the killed processes and return to step 1506 in order for the Android kernel memory allocator to allocate the free pages to the new process. If there is sufficient free pages to allocate the new process, the free pages may be allocated and the method may end. If there still is not enough available memory, the method may process to step 1508.

While the above was described with respect to the high zone being under memory pressure, the process may also be performed for the low zone when the low zone is under memory pressure.

The advantage of the above method is that the killing of processes is focused on process in the zone under memory pressure rather than zone not under memory pressure. This also results in fewer process getting killed overall, and more quickly, as compared with conventional methods that consider only OOM score and LRU list.

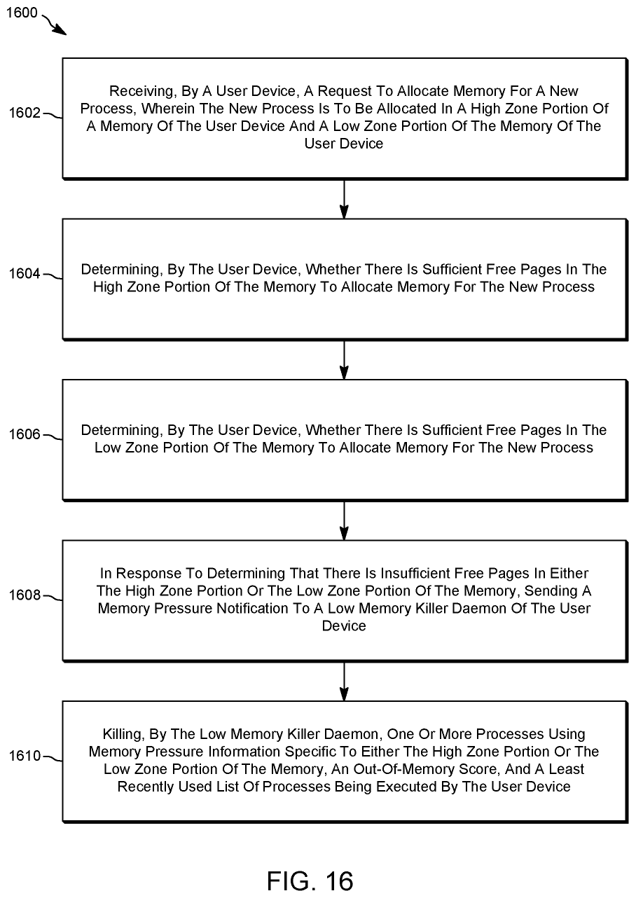

FIG. 16 depicts a flow chart of a method according to one or more aspects discussed herein. At step 1602, a user device (e.g., user device 108) may receive a request to allocate memory for a new process. The new process is to be allocated memory in a high zone portion of a memory of the user device and memory in a low zone portion of the memory of the user device. At step 1604, the user device may determine whether there is sufficient free pages in the high zone portion of the memory to allocate memory for the new process. At step 1606, the user device may determine whether there is sufficient free pages in the low zone portion of the memory to allocate memory for the new process. At step 1608, the user device may, in response to determining that there is insufficient free pages in either the high zone portion or the low zone portion of the memory, send a memory pressure notification to a low memory killer daemon of the user device. At step 1610, the low memory killer daemon may kill one or more processes using memory pressure information specific to either the high zone portion or the low zone portion of the memory, an out-of-memory score, and a least recently used list of processes being executed by the user device.

FIG. 17 illustrates a computer system 1700 in which embodiments of the present disclosure, or portions thereof, may be implemented as computer-readable code. For example, one or more (e.g., each) of the management server 102 and/or user devices 108 may be implemented in the computer system 1700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 2 and 14-16.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above-described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1718, a removable storage unit 1722, and a hard disk installed in hard disk drive 1712.

Various embodiments of the present disclosure are described in terms of this example computer system 1700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1704 may be a special purpose or a general purpose processor device specifically configured to perform the functions discussed herein. The processor device 1704 may be connected to a communications infrastructure 1706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 1700 may also include a main memory 1708 (e.g., random access memory, read-only memory, etc.), and may also include a secondary memory 1710. The secondary memory 1710 may include the hard disk drive 1712 and a removable storage drive 1714, such as a floppy disk drive, a magnetic tape drive, an optical disk drive, a flash memory, etc.

The removable storage drive 1714 may read from and/or write to the removable storage unit 1718 in a well-known manner. The removable storage unit 1718 may include a removable storage media that may be read by and written to by the removable storage drive 1714. For example, if the removable storage drive 1714 is a floppy disk drive or universal serial bus port, the removable storage unit 1718 may be a floppy disk or portable flash drive, respectively. In one embodiment, the removable storage unit 1718 may be non-transitory computer readable recording media.

In some embodiments, the secondary memory 1710 may include alternative means for allowing computer programs or other instructions to be loaded into the computer system 1700, for example, the removable storage unit 1722 and an interface 1720. Examples of such means may include a program cartridge and cartridge interface (e.g., as found in video game systems), a removable memory chip (e.g., EEPROM, PROM, etc.) and associated socket, and other removable storage units 1722 and interfaces 1720 as will be apparent to persons having skill in the relevant art.

Data stored in the computer system 1700 (e.g., in the main memory 1708 and/or the secondary memory 1710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1700 may also include a communications interface 1524. The communications interface 1724 may be configured to allow software and data to be transferred between the computer system 1700 and external devices. Exemplary communications interfaces 1724 may include a modem, a network interface (e.g., an Ethernet card), a communications port, a PCMCIA slot and card, etc. Software and data transferred via the communications interface 1724 may be in the form of signals, which may be electronic, electromagnetic, optical, or other signals as will be apparent to persons having skill in the relevant art. The signals may travel via a communications path 1726, which may be configured to carry the signals and may be implemented using wire, cable, fiber optics, a phone line, a cellular phone link, a radio frequency link, etc.

The computer system 1700 may further include a display interface 1702. The display interface 1702 may be configured to allow data to be transferred between the computer system 1700 and external display 1730. Exemplary display interfaces 1702 may include high-definition multimedia interface (HDMI), digital visual interface (DVI), video graphics array (VGA), etc. The display 1730 may be any suitable type of display for displaying data transmitted via the display interface 1702 of the computer system 1700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1708 and secondary memory 1710, which may be memory semiconductors (e.g., DRAMs, etc.). These computer program products may be means for providing software to the computer system 1700. Computer programs (e.g., computer control logic) may be stored in the main memory 1708 and/or the secondary memory 1710. Computer programs may also be received via the communications interface 1724. Such computer programs, when executed, may enable computer system 1700 to implement the present methods as discussed herein. In particular, the computer programs, when executed, may enable processor device 1704 to implement the methods illustrated by FIGS. 2 and 14-16, as discussed herein. Accordingly, such computer programs may represent controllers of the computer system 1700. Where the present disclosure is implemented using software, the software may be stored in a computer program product and loaded into the computer system 1700 using the removable storage drive 1714, interface 1720, and hard disk drive 1712, or communications interface 1724.

The processor device 1704 may comprise one or more modules or engines configured to perform the functions of the computer system 1700. Each of the modules or engines may be implemented using hardware and, in some instances, may also utilize software, such as corresponding to program code and/or programs stored in the main memory 1708 or secondary memory 1710. In such instances, program code may be compiled by the processor device 1704 (e.g., by a compiling module or engine) prior to execution by the hardware of the computer system 1700. For example, the program code may be source code written in a programming language that is translated into a lower level language, such as assembly language or machine code, for execution by the processor device 1704 and/or any additional hardware components of the computer system 1700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 1700 to perform the functions disclosed herein. It will be apparent to persons having skill in the relevant art that such processes result in the computer system 1700 being a specially configured computer system 1700 uniquely programmed to perform the functions discussed above.

Techniques consistent with the present disclosure provide, among other features, method and system for memory management on the basis of zone allocations. While various illustrative embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method comprising:
receiving, by a user device, a request to allocate memory for a new process, wherein the new process is to be allocated memory in a high zone portion of a memory of the user device and memory in a low zone portion of the memory of the user device;
determining, by the user device, whether there is sufficient free pages in the high zone portion of the memory to allocate memory for the new process;
determining, by the user device, whether there is sufficient free pages in the low zone portion of the memory to allocate memory for the new process;
in response to determining that there is insufficient free pages in either the high zone portion or the low zone portion of the memory, sending a memory pressure notification to a low memory killer daemon of the user device; and
killing, by the low memory killer daemon, one or more processes using memory pressure information specific to either the high zone portion or the low zone portion of the memory, an out-of-memory score, and a least recently used list of processes being executed by the user device.

2. The method of claim 1, wherein the memory pressure notification comprises the memory pressure information specific to either the high zone portion or the low zone portion of the memory.

3. The method of claim 1, wherein the memory pressure information is specific to the high zone portion of the memory.

4.-6. (canceled)

7. An apparatus associated with an entity, the apparatus comprising:
a processor; and
a memory storing instructions that, when executed by the processor, cause the apparatus to:
receive a request to allocate memory for a new process, wherein the new process is to be allocated memory in a high zone portion of the memory and memory in a low zone portion of the memory;
determine whether there is sufficient free pages in the high zone portion of the memory to allocate memory for the new process;
determine whether there is sufficient free pages in the low zone portion of the memory to allocate memory for the new process;
in response to determining that there is insufficient free pages in either the high zone portion or the low zone portion of the memory, send a memory pressure notification to a low memory killer daemon of the apparatus; and
kill, by the low memory killer daemon, one or more processes using memory pressure information specific to either the high zone portion or the low zone portion of the memory, an out-of-memory score, and a least recently used list of processes being executed by the apparatus.

8. The apparatus of claim 7, wherein the memory pressure notification comprises the memory pressure information specific to either the high zone portion or the low zone portion of the memory.

9. The apparatus of claim 7, wherein the memory pressure information is specific to the high zone portion of the memory.

10.-12. (canceled)

13. A system comprising:
a memory management computing device; and
a user device,
wherein the memory management computing device is configured to transmit to the user device instructions to configure the user device,
wherein the user device is configured to:
receive a request to allocate memory for a new process, wherein the new process is to be allocated memory in a high zone portion of a memory of the user device and memory in a low zone portion of the memory of the user device;
determine whether there is sufficient free pages in the high zone portion of the memory to allocate memory for the new process;
determine whether there is sufficient free pages in the low zone portion of the memory to allocate memory for the new process;
in response to determining that there is insufficient free pages in either the high zone portion or the low zone portion of the memory, send a memory pressure notification to a low memory killer daemon of the user device; and
kill, by the low memory killer daemon, one or more processes using memory pressure information specific to either the high zone portion or the low zone portion of the memory, an out-of-memory score, and a least recently used list of processes being executed by the user device.

14. The system of claim 13, wherein the memory pressure notification comprises the memory pressure information specific to either the high zone portion or the low zone portion of the memory.

15. The system of claim 13, wherein the memory pressure information is specific to the high zone portion of the memory.

16.-18. (canceled)

19. A method comprising:
transmitting, by a memory management computing device and to a user device, a first set of instructions to configure the user device to monitor memory usage of the user device and collect monitored memory usage information;
receiving, by the memory management computing device and from the user device, the monitored memory usage information of the user device;
analyzing, by the memory management computing device, the monitored memory usage information of the user device to produce an analysis of the monitored memory usage information; and
outputting, by the memory management computing device, the analysis of the monitored memory usage information,
wherein the analysis of the monitored memory usage information comprises a system level memory usage view of the user device, a memory usage view of a high zone portion of the memory of the user device, and a memory usage view of a low zone portion of the memory of the user device.

20. The method of claim 19, wherein the system level memory usage view comprises a cached proportional set size, plots of a cached kernel, free memory, a memory pressure low indication, a memory pressure medium indication, and a memory pressure high indication.

21. The method of claim 19, wherein the memory usage view of the high zone portion of the user device comprises plots of high memory free pages, a high memory kswapd threshold, and a high memory zone balance threshold

22. The method of claim 19, wherein the memory usage view of the low zone portion of the user device comprises plots of low memory free pages, a low memory kswapd threshold, and a low memory zone balance threshold.

23.-25. (canceled)

26. An apparatus associated with an entity, the apparatus comprising:
a processor; and
a memory storing instructions that, when executed by the processor, cause the apparatus to:
transmit, to a user device, a first set of instructions to configure the user device to monitor memory usage of a user device and collect monitored memory usage information;
receive, from the user device, the monitored memory usage information of the user device;
analyze the monitored memory usage information of the user device to produce an analysis of the monitored memory usage information; and
output the analysis of the monitored memory usage information,
wherein the analysis of the monitored memory usage information comprises a system level memory usage view of the user device, a memory usage view of a high zone portion of the memory of the user device, and a memory usage view of a low zone portion of the memory of the user device.

27. The apparatus of claim 26, wherein the system level memory usage view comprises a cached proportional set size, plots of a cached kernel, free memory, a memory pressure low indication, a memory pressure medium indication, and a memory pressure high indication.

28. The apparatus of claim 26, wherein the memory usage view of the high zone portion of the memory of the user device comprises plots of high memory free pages, a high memory kswapd threshold, and a high memory zone balance threshold

29. The apparatus of claim 26, wherein the memory usage view of the low zone portion of the memory of the user device comprises plots of low memory free pages, a low memory kswapd threshold, and a low memory zone balance threshold.

30.-32. (canceled)

33. A system comprising:
a memory management computing device; and
a user device,
wherein the memory management computing device is configured to:
transmit, to a user device, a first set of instructions to configure the user device to monitor memory usage of a user device and collect monitored memory usage information;
receive, from the user device, the monitored memory usage information of the user device;
analyze the monitored memory usage information of the user device to produce an analysis of the monitored memory usage information; and
output the analysis of the monitored memory usage information,
wherein the analysis of the monitored memory usage information comprises a system level memory usage view of the user device, a memory usage view of a high zone portion of the memory of the user device, and a memory usage view of a low zone portion of the memory of the user device,
wherein the user device is configured to:
receive the first set of instruction;
monitor memory usage of the user device;
collect the monitored memory usage information; and
transmit, to the memory management computing device, the monitored memory usage information.

34. The system of claim 33, wherein the system level memory usage view comprises a cached proportional set size, plots of a cached kernel, free memory, a memory pressure low indication, a memory pressure medium indication, and a memory pressure high indication.

35. The system of claim 33, wherein the memory usage view of the high zone portion of the memory of the user device comprises plots of high memory free pages, a high memory kswapd threshold, and a high memory zone balance threshold

36. The system of claim 33, wherein the memory usage view of the low zone portion of the memory of the user device comprises plots of low memory free pages, a low memory kswapd threshold, and a low memory zone balance threshold.

37.-39. (canceled)
